(19) United States
(12) Patent Application Publication
(10) Pub. No.: US 2010/0176802 A1
(43) Pub. Date: Jul. 15, 2010

(54) PORTABLE ELECTRONIC DEVICE HAVING A ROTARY UNIT

(75) Inventor: Pascal Huguet, Change (FR)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/063,722

(22) PCT Filed: Aug. 11, 2006
(86) PCT No.: PCT/IB06/52779

§ 371 Date: Feb. 13, 2008

(30) Foreign Application Priority Data
Aug. 16, 2005 (EP) 05300666.4

(51) Int. Cl. G01B 7/30

(52) U.S. Cl. 324/207.25

(57) ABSTRACT

The present invention relates to a portable electronic device comprising: —a housing; —a rotary unit, which can be rotated relative to the housing, and —detection means for detecting a rotational position of the rotary unit. Said detection means comprises: —a magnetic transmitter (10) attached to the rotary unit, for supplying a magnetic field, —a magnetic receiver (11) attached to the housing, which receiver comprises a magnetic field sensor (103) and a magnetic flux guiding arrangement for increasing the magnetic field through the magnetic field sensor.

### FIELD OF THE INVENTION

This invention relates generally to a portable electronic apparatus including a rotary device and detection means for detecting a rotation angle of said rotary device.

The present invention relates to a device for detecting a rotation angle of a rotation around an axis of rotation.

### BACKGROUND OF THE INVENTION

Modern portable electronic apparatuses, such as mobile phones, comprise a camera unit for supplying photos and video sequences. This camera can be rotary in order to facilitate photo or video sequence capture. To this end, the portable electronic apparatus have to comprise a device for detecting a rotation angle of the camera unit.

The European patent no 1 362 221 describes a device for detecting a rotation angle of a rotation around an axis of rotation and comprising a transducer magnet for generating a magnetic field and a plurality of magnetic-field-sensitive sensor elements for detecting the magnetic field, with the transducer magnet and the plurality of magnetic-field-sensitive sensor elements being arranged such that, when rotating around the axis of rotation, the plurality of magnetic-field-sensitive sensor elements circles around the same relative to the transducer magnet. Such a device is rather complex and can hardly be implemented in a portable electronic apparatus.

### SUMMARY OF THE INVENTION

It is an object of the invention to propose a portable electronic device comprising a device for detecting a rotation angle of a rotary unit, e.g. a camera unit, which is easier to implement than the one of the prior art.

It is another object of the invention to propose a device for detecting a rotation angle of a rotation around an axis of rotation which is cost effective compared to the one of the prior art.

To this end, the portable electronic device in accordance with the invention is characterized in that it comprises:
a housing;
a rotary unit, which can be rotated relative to the housing; and
detection means for detecting a rotational position of the rotary unit.
   Said detection means comprises:
a magnetic transmitter attached to the rotary unit, for supplying a magnetic field,
a magnetic receiver attached to the housing, which receiver comprises a magnetic field sensor and a magnetic flux guiding arrangement for increasing the magnetic field through the magnetic field sensor.

The device for detecting a rotation angle in accordance with the invention is characterized in that it comprises:
a magnetic transmitter attached to the rotary unit, for supplying a magnetic field,
a magnetic receiver attached to the housing, which receiver comprises a magnetic field sensor and a magnetic flux guiding arrangement for increasing the magnetic field through the magnetic field sensor.

According to an exemplary embodiment of the invention, the magnetic flux guiding arrangement comprises two plates, each plate being connected on opposite ends of the magnetic field sensor.

Beneficially, the magnetic flux guiding arrangement comprises a magnetically permeable material.

The magnetic transmitter is a for example a magnet, and the magnetic field sensor is, for example, a Hall effect sensor.

According to another exemplary embodiment of the invention, the rotary unit is a camera unit for capturing image and/or video sequence. The portable electronic device may comprise image processing means for modifying the image captured by the camera unit depending on the rotational position detected by the magnetic means. The portable electronic device may further comprise a display, the camera unit may comprise a camera lens, the detection means being able to detect a predetermined rotational position of the camera unit where the display and the camera lens are on opposite sides of the housing, and the image processing means being adapted to reverse the image captured by the camera unit if said camera unit is in said predetermined rotational position.

The portable electronic device is preferably a cordless or a mobile phone.

These and other aspects of the invention will be apparent from and will be elucidated with reference to the embodiments described hereinafter.

### BRIEF DESCRIPTION OF THE DRAWINGS

The present invention will now be described in more detail, by way of example, with reference to the accompanying drawings, wherein:

FIG. 1 shows a portable electronic device according to an exemplary embodiment of the present invention;

FIG. 2 shows a perspective view of a camera unit and magnetic detection means according to an exemplary embodiment of the present invention;

FIG. 3 shows an exploded view of the camera unit and the magnetic detection means according to the same exemplary embodiment of the present invention;

FIGS. 4 to 6 show a particular embodiment of the structure of the magnetic detection means;

FIG. 7 and FIG. 8 illustrate the use of a portable electronic device in a first operation mode and in a second operation mode; and

FIG. 9 and FIG. 10 are cross-section views illustrating the operation of the magnetic detection means in order to detect the rotational position of the camera unit.

### DETAILED DESCRIPTION OF THE INVENTION

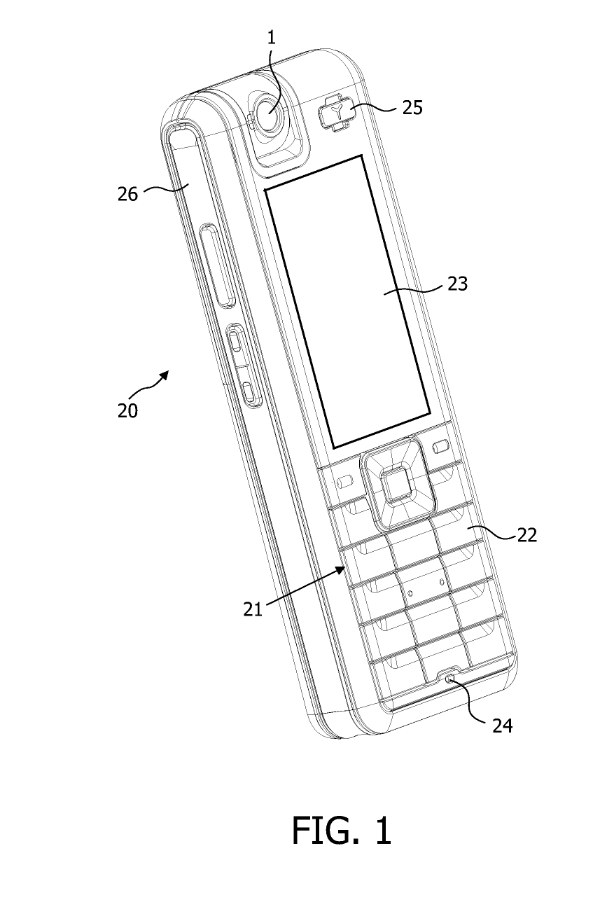

Referring to FIG. 1 of the drawings, a portable electronic device 20 according to an exemplary embodiment of the present invention is depicted. This portable electronic device is either a cordless phone or a mobile phone. However, it will be apparent to a person skilled in the art that the portable electronic device may be another device such a personal digital assistant (PDA), a camera, etc. The cordless or mobile phone comprises a housing 26 including a key entry section 21 which comprises a number of button switches 22 for dial entry and other functions. A display unit 23 is disposed above the key entry section 21. A microphone 24 and a loudspeaker 25, located at opposite ends of the phone 20, are provided for receiving audio signals from the surrounding area and transmitting audio signal coming from the telecommunications network, respectively.

A camera unit 1, the outer lens of which is visible, is incorporated into the phone 20, above the display unit 23. This camera unit is capable of capturing a first picture showing information about the callee, for example his face. This camera unit is also capable of capturing a second picture showing information about the caller, for example his face, so that the caller can control the information he sends to the callee. The display unit 23 may comprise two different frames, a first frame of great size showing the first picture and a second frame having a reduced size and showing the second picture.

In order to achieve such a video transmission/reception, the phone 20 comprises audio and video codecs, i.e. encoders and decoders (not represented). As an example, the video codec is based on the MPEG4 or the 11.263 video encoding/decoding standard. Similarly, the audio codec is based, for example, on the MPEG-AAC or G.729 audio encoding/decoding standard.

The camera unit 1 is rotary mounted relative to the housing 26 of the phone 20. The phone comprises magnetic detection means for detection the rotation angle of the camera unit.

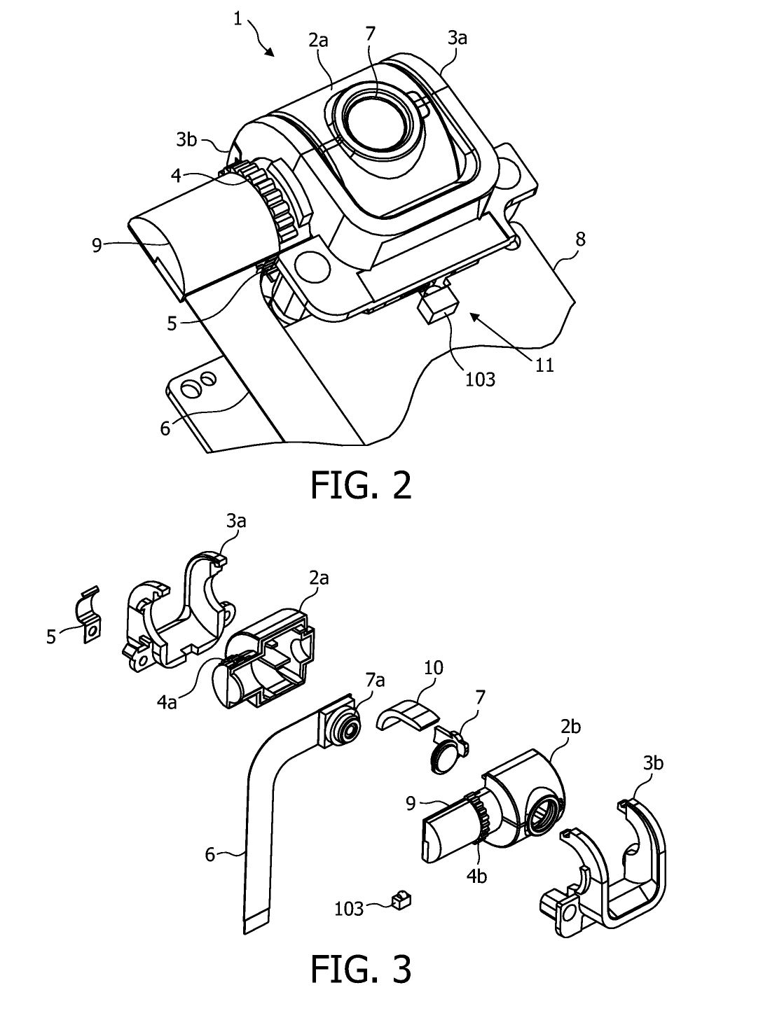

Referring to FIG. 2, the detection means are described in more detail. The camera unit 1 comprises a first 2a and a second 2b half-shells surrounding a camera lens 7. This camera unit 1 is inserted between two half-bearings 3a and 3b, said half-bearing being coupled to each other in such a way the camera unit is able to rotate therein. The half-bearings 3a and 3b are fixed to the housing of the phone 20.

The camera unit may be rotated manually. To this end, a crown gear 4 fixed to the camera unit 1 is coupled to a flexible plate 5 fixed to the housing. The coupling between the crown gear 4 and the flexible plate 5 is such that, when the camera unit rotates, the gear teeth of the crown gear 4 press against the flexible plate 5, and when the rotation is stopped, the flexible plate 5 rests between two gear teeth. The position and number of gear teeth depend on the elementary rotation to be achieved. As an example, the gear teeth are dimensioned so as to achieve a rotation of 15 degrees per gear tooth and the crown gear 4 comprises 19 gear teeth so as to achieve a maximum rotation of 270 degrees.

A ribbon cable 6 coupled to the camera unit 1 permits the transmission of the video data captured by the camera unit, said cable being connected to a connector fixed on a printed-circuit board (PCB) 8 attached to the housing. The ribbon cable 6 can be wrapped and unwrapped around a foil support 9, which is fixed to the crown gear 4 so that the foil support 9, the crown gear 4 and the camera unit 1 rotates at the same time. A magnetic receiver 11 including a magnetic field sensor 103, e.g. a Hall effect sensor, is fixed to the PCB 8.

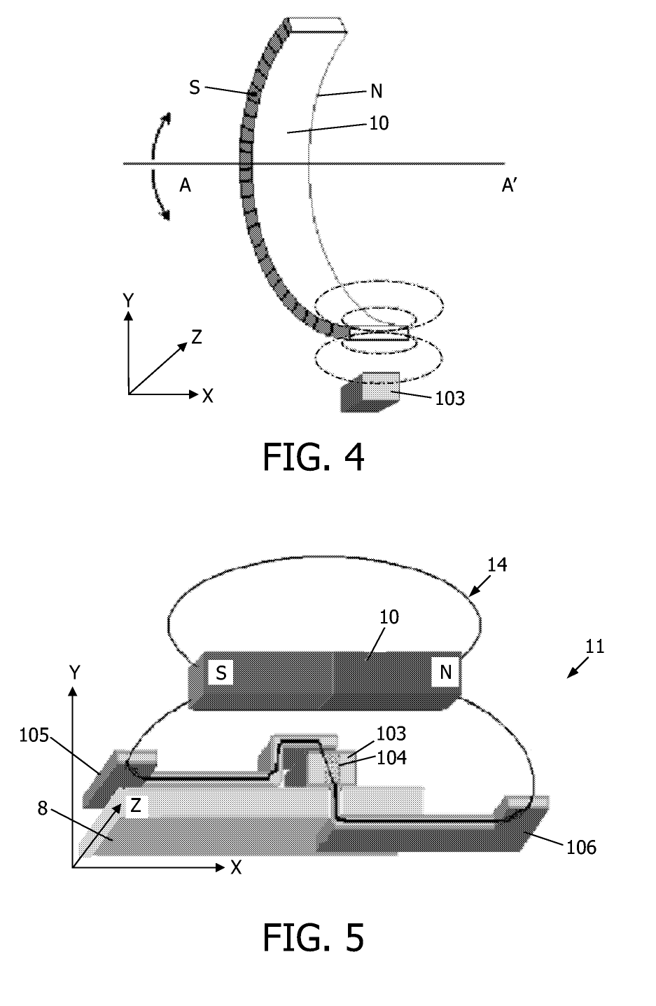

Turning now to FIG. 3, an exploded view of the camera unit and magnetic detections means is given. The two half-bearings 3a and 3b surrounding the camera unit can be seen on each side of the exploded view, the flexible plate 5 being fixed to the half-bearing 3a. Then, the first 2a and second 2b half-shells forming the camera unit are shown. According to the exemplary embodiment of the invention illustrated in this exploded view, the half shell 2b, the half crown gear 4b and the foil support 9 are made of one piece of material. Similarly, the half shell 2a and a half crown gear 4a are also made of one piece of material. However, it will be apparent to a skilled person that alternative are possible, e.g. the foil support 9 and the crown gear 4 may be separate parts that are fixed to the assembly of the two half-shells 2a and 2b. The camera unit also comprises the camera lens 7 and a camera sensor 7a (e.g. CMOS or CCD) which is connected to the ribbon cable 6.

FIG. 3 also shows a magnetic transmitter 10, e.g a magnet, which is attached to one of the half-shell 2a or 2b so that the magnetic transmitter and the camera unit rotate at the same time. The magnetic field sensor 103, which is attached to the housing, together with the magnetic transmitter 10, which is attached to the camera unit, form the detection means.

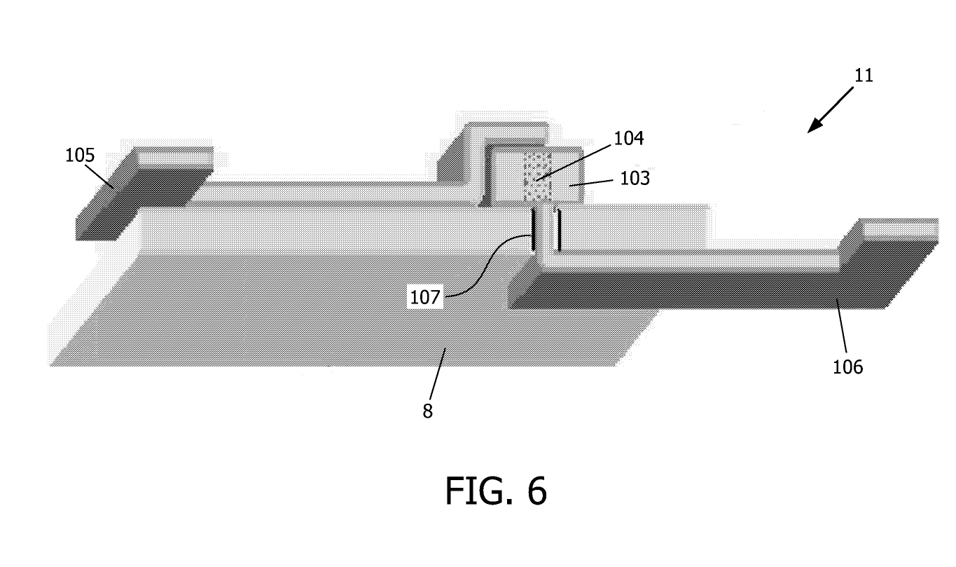

FIGS. 4 to 6 show a particular embodiment of the structure of the magnetic detection means in more detail. As described before, the magnetic detection means comprises a magnetic transmitter 10, e.g. a magnet, attached to the camera unit, and a magnetic receiver attached to the housing of the phone, which magnetic receiver includes a magnetic field sensor 103, e g a Hall effect sensor.

FIG. 4 shows that the direction of the magnetic field within the rotary magnet 10 is along the X-axis from south S to north N but that the best sensitivity axis of the magnetic receiver can be along the Y-axis. Therefore some additional features are needed in order to solve this issue.

As described before, the magnet 10 rotates around an AA′ axis and the distance between the magnet 10 and the magnetic field sensor 103 is variable as a function of the position of the rotary magnet 10. As a consequence, the magnetic field received by the magnetic field sensor might be below a minimum magnetic field threshold detectable by said sensor. In such a case, the magnetic detection means would not operate properly. As it will be described in more detail in the following figures, the magnetic detection means according to the invention has the property of locally improving the magnetic field intensity received by the magnetic field sensor in order to solve this issue.

FIG. 5 shows the magnetic detection means according to the invention.

The magnetic detection means includes:
the rotary magnet 10;
the stationary Hall effect sensor 103, said sensor having a sensitive area 104 and being soldered on the PCB 8;
two magnetic flux guiding elements 105 and 106 in the form of plates comprising a magnetically permeable material, said guiding elements being soldered on the PCB 8 and being connected on opposite sides of the Hall effect sensor 103.
   The guiding elements receive the magnetic field 14 (please note that reference 14 is only a symbolic notation) from the magnet 10 along the X-axis and set the magnetic field along the Y-axis, which is the best sensitivity direction of the Hall effect sensor 103. Thus, the two guiding elements increase the magnetic field intensity which flows towards the sensitive area 104 of the Hall effect sensor 103. The magnetic field sensor 103 and the magnetic flux guiding means 105 and 106 form the magnetic receiver 11.

FIG. 6 is a detailed view of an embodiment of the magnetic flux guiding plates around the Hall effect sensor. The two guiding plates 105 and 106 are located on opposite ends of the PCB 8. The upper guiding plate 105 covers the sensitive area 104 of the Hall effect sensor 103. The lower guiding plate 106 passes through a hole 107 of the PCB in order to be located as close as possible of the Hall effect sensor 103. This embodiment increases the magnetic field amplitude received by the two guiding plates at the sensor sensitive area 104. It will be obvious to a skilled person that the magnetic flux guiding arrangement might differ from the two guiding plates arrangement described above. For example, the lower guiding plate can be replaced by a metallization on the PCB.

According to this embodiment of the invention, the magnetic detection means only comprises a few components and is adapted to set the magnetic field according to the best sensitivity axis of the sensor.

According to another embodiment of the invention, at least two positions of the camera units are detected by the magnetic detection means.

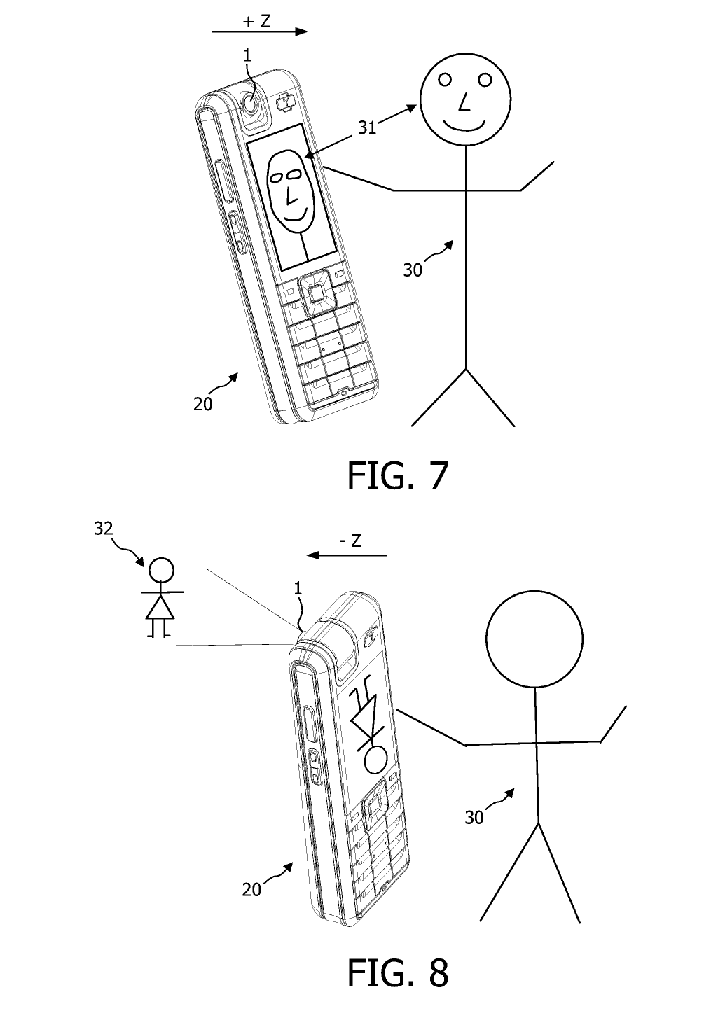

According to a first position of the camera unit 1 shown in FIG. 7, where the camera lens is on the same side of the housing as the display unit 23 (i.e. the camera lens is orientated in the +Z direction), the camera unit is able to capture a picture showing for example the face 31 of the callee 30. This capture mode is also referred to as self-portrait mode. The portable electronic device 20 is then able to display the captured picture.

According to a second position of the camera unit 1 shown in FIG. 8, where the camera lens is on a side of the housing opposite to the side of the display unit 23 (i.e. the camera lens is orientated in the −Z direction), said camera unit is able to capture a picture showing a third party 32 in the vicinity of the callee 30. This capture mode is also referred to as camcorder mode. The portable electronic device is then able to display the captured picture. As shown in FIG. 8, if no image processing is performed on the captured image, said image of the third party 32 is reversed on the display unit, i.e. the person is displayed from bottom to top instead of top to bottom, which is not suitable. That is why the portable electronic device in accordance with the invention comprises conventional image processing means (not represented) for reversing the picture so that a suitable picture is displayed. Such image processing means are adapted to reverse the captured image depending on the position of the camera unit, namely when the camera lens is orientated in the −Z direction, based on the information supplied by the magnetic detection means.

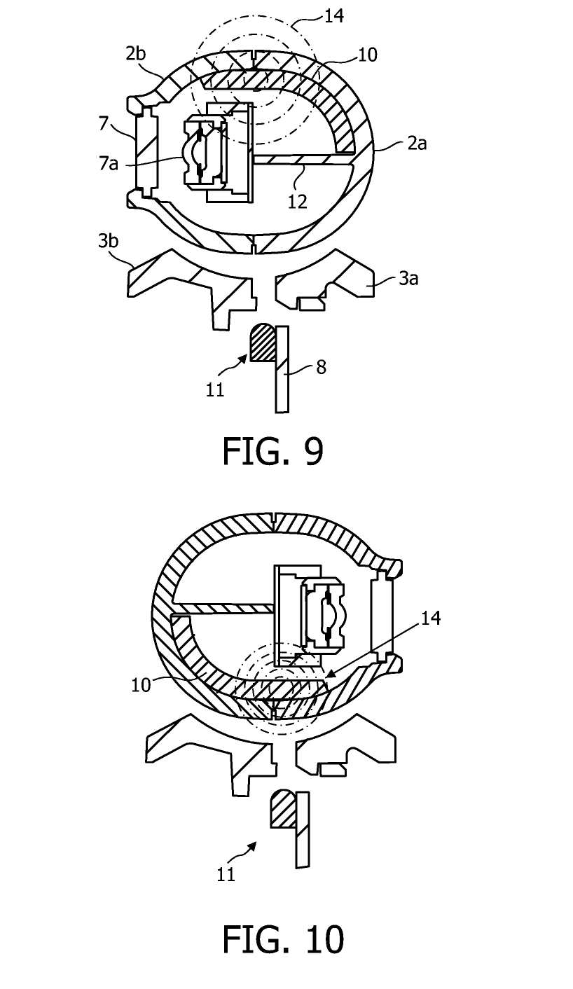

FIG. 9 and FIG. 10 illustrate the operation of the magnetic detection means in order to detect the rotational position of the camera unit. According to these Figures, the magnet 10 is fixed to the half-shell 2A using a rib 12 which is part of the first half-shell 2a.

According to FIG. 9, when the camera unit is in the camcorder mode, as shown in FIG. 8, the magnetic transmitter 10 is in the far field of the magnetic receiver 11 so that said receiver is able to receive a minimum magnetic field 14 (once again reference 14 is only a symbolic notation) and outputs a first voltage which activates the image processing means in order to reverse the pictures to be displayed.

According to FIG. 10, when the camera unit is in the self-portrait mode, as shown in FIG. 7, the magnetic transmitter 10 is in the near field of the magnetic receiver 11 so that said receiver is able to receive a maximum magnetic field 14 and outputs a second voltage which does not activate the image processing means.

Thus, when the camera unit is in an intermediary position between the two above-described positions, where the rib 12 is substantially aligned with the PCB 8, the magnetic receiver 11 receives a medium magnetic field 14. As a consequence, if the voltage output by the magnetic receiver is higher than a threshold level, then the camera unit is in the self-portrait mode and the image is not processed. On the contrary, if the voltage output by the magnetic receiver is lower than the threshold level, then the camera unit is in the camcorder mode and the image is reversed using the image processing means.

The operation of the magnetic detection means has been depicted in the context of FIGS. 7 to 10 but it will be apparent to a skilled person that the invention is not restricted to this particular position of the magnetic receiver. The invention may be applicable to other configurations of the magnetic means provided that a threshold signal delivered by the magnetic field sensor is determined for a threshold rotational position of the camera unit corresponding to a switch between a first camera mode to a second camera mode, the image processing means being then adapted to modify an image captured by the camera unit for a given rotational position (corresponding to the first or second camera mode) of the camera unit depending on a comparison of the value of the signal delivered by the magnetic field sensor for said given rotational position with the threshold value.

It is to be noted that the invention is neither limited by the number of available camera modes which can be more than two, nor limited by the processing function implemented by the image processing means which can be other geometric transformations, for example rotation or translation, than the reversing function.

It is also to be noted that the invention is not limited to the detection of the rotational position of a camera unit but can also be applied to the rotation of any other rotary device. The magnetic detection means according to the invention could notably be used in any device which requires low cost magnetic detection position.

It should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa. The invention may be implemented by means of hardware comprising several distinct elements, and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

1. A portable electronic device (20) comprising:
a housing (26);
a rotary unit (1), which can be rotated relative to the housing; and
detection means for detecting a rotational position of the rotary unit, said detection means comprising:
a magnetic transmitter (10) attached to the rotary unit, for supplying a magnetic field,
a magnetic receiver (11) attached to the housing, which receiver comprises a magnetic field sensor (103) and a magnetic flux guiding arrangement for increasing the magnetic field through the magnetic field sensor.

2. A portable electronic device as claimed in claim 1, wherein the magnetic flux guiding arrangement comprises two plates (105,106), each plate being connected on opposite ends of the magnetic field sensor (103).

3. A portable electronic device as claimed in claim 1, wherein the magnetic flux guiding arrangement comprises a magnetically permeable material.

4. A portable electronic device as claimed in claim 1, wherein the magnetic transmitter (10) is a magnet.

5. A portable electronic device as claimed in claim 1, wherein the magnetic field sensor (103) is a Hall effect sensor.

6. A portable electronic device as claimed in claim 1, wherein the rotary unit is a camera unit for capturing image and/or video sequence.

7. A portable electronic device as claimed in claim 6, further comprising image processing means for modifying the image captured by the camera unit depending on the rotational position detected by the magnetic means.

8. A portable electronic device (20) as claimed in claim 7, further comprising a display (23), wherein the camera unit (1) comprises a camera lens (7), wherein the detection means are able to detect a predetermined rotational position of the camera unit where the display and the camera lens are on opposite sides of the housing (26), and wherein the image processing means are adapted to reverse the image captured by the camera unit if said camera unit is in said predetermined rotational position.

9. A portable electronic device as claimed in claim 1, wherein the device is a cordless or mobile phone.

10. A device for detecting a rotation angle of a rotation around an axis of rotation, said device comprising:
a rotary magnetic transmitter (10), for supplying a magnetic field,
a fixed magnetic receiver (11), which receiver comprises a magnetic field sensor (103) and a magnetic flux guiding arrangement for increasing the magnetic field through the magnetic field sensor.
